(19) United States
(12) Patent Application Publication
(10) Pub. No.: US 2024/0359770 A1
(43) Pub. Date: Oct. 31, 2024

(54) DRIVE SYSTEM FOR AN ELECTRIC BICYCLE HAVING AN EMERGENCY MODE, AND CONTROL METHOD

(71) Applicant: BROSE ANTRIEBSTECHNIK GMBH & CO. KOMMANDITGESELLSCHAFT, BERLIN, Berlin (DE)

(72) Inventors: Christian WILMS, Berlin (DE); Thomas KLETT, Berlin (DE); Martin-Maximilian WAHL, Hohen Neuendorf (DE)

(21) Appl. No.: 18/575,751

(22) PCT Filed: Jul. 7, 2022
(86) PCT No.: PCT/EP2022/068922

§ 371 Date: Feb. 1, 2024

(30) Foreign Application Priority Data
Jul. 8, 2021 (DE) 10 2021 207 255.0

(51) Int. Cl. B62M 6/50; B62M 6/80

(52) U.S. Cl. CPC B62M 6/50; B62M 6/80

(57) ABSTRACT

It is provided a drive system for an electric bicycle, in which an electronic control system is provided for a power control of first and second electric motors of the drive system in an emergency mode, wherein the emergency mode is active when the first and second electric motors cannot be supplied with electric current via an energy accumulator of the drive system, and via the electronic control system, at least one of the first and second electric motors can at least temporarily be operated regeneratively in the emergency mode, in order to convert a power applied by muscle force at the drive shaft into electric energy, which provides for a stepless variation of a gear ratio of a superposition transmission also in the emergency mode.

### BACKGROUND

The proposed solution relates to a drive system for an electric bicycle and to a control method.

It is known to employ two electric motors in combination with a superposition transmission including a planetary gear stage on an electric bicycle, hence on a so-called E-Bike or Pedelec, in order to steplessly adjust a gear ratio between input and output. A corresponding drive system on the one hand includes a drive shaft via which a driving torque generated by a rider of the electric bicycle can be introduced and on which pedals are provided therefor. Via an output shaft of the drive system to be coupled with a wheel of the electric bicycle a driving torque introduced at the drive shaft and/or an electromotively generated torque then is transmitted to a wheel, usually a rear wheel of the electric bicycle. Via the superposition transmission the drive shaft and the output shaft are coupled with each other, wherein a torque generated by a first electric motor of the two electric motors can at least partly be transmitted to the output shaft. Via the second electric motor of the two electric motors a gear ratio is steplessly adjustable so that the electric bicycle can be accelerated via a driving torque of the first electric motor without the drive shaft therefor having to be rotated more quickly or with greater force. In this way, the second electric motor also serves to support the torque generated by the first electric motor and therefor can rotate a rotor shaft in different directions of rotation depending on the gear ratio. A driving device for an electric bicycle with a comparable superposition transmission and two electric motors is known for example from WO 2019/175022 A1.

In the drive system known from WO 2019/175022 A1 an emergency mode is provided, which is realized by a freewheel. The freewheel ensures that a power applied at the drive shaft by muscle force can still be utilized for driving the electric bicycle, even if an electric current for operating the first and second electric motors cannot be provided via an energy accumulator (hence e.g. a battery) of the drive system. However, it is a disadvantage of the emergency mode described in WO 2019/175022 A1 that then only a permanently set gear ratio is specified and the gear ratio of the superposition transmission can no longer be steplessly varied. A stepless automatic transmission function, which is provided in a normal mode of the drive system, thus no longer is available. The permanently set gear ratio in the emergency mode then for example can correspond to the smallest gear ratio which can also be utilized in a normal mode. With such a small gear ratio, however, only comparatively low speeds can be realized, even if the drive shaft is rotated by muscle force with a high pedaling frequency.

### SUMMARY

Against this background it is the object underlying the proposed solution to provide a drive system improved in this respect.

This object is achieved with a drive system with features as described herein and with a control method of with features as described herein.

A proposed drive system comprises at least
a drive shaft,
an output shaft for driving a wheel of an electric bicycle,
a first electric motor, which drives a first rotor shaft,
a second electric motor, which drives a second rotor shaft,
a superposition transmission, whose gear ratio is steplessly adjustable by means of the first and second electric motors and via which the drive shaft and the output shaft are coupled with each other, wherein a torque generated by the first electric motor can at least partly be transmitted to the output shaft, and
an energy accumulator for supplying the first and second electric motors with electric current (in a normal mode of the drive system).

In addition, there is provided an electronic control system (e.g. provided via a control software) for a power control of the first and second electric motors in an emergency mode of the drive system. The emergency mode here is active when the first and second electric motors cannot be supplied with electric current via the energy accumulator, for example because the energy accumulator has been removed, is defective or empty. Via the electronic control system, at least one of the first and second electric motors then can at least temporarily be operated regeneratively, in order to convert a (mechanical) power applied at the drive shaft by muscle force into electric energy, which provides for a stepless variation of the gear ratio of the superposition transmission also in the emergency mode.

The idea underlying the proposed solution thus is to provide an electronic control system which is adapted to at least temporarily regeneratively operate at least one of the first and second electric motors in the emergency mode and hence provide for a stepless variation of the gear ratio of the superposition transmission even in the emergency mode. For the automatic transmission function provided via the superposition transmission, the necessary electrical power consequently is provided in the emergency mode by at least one of the two electric motors, wherein the two electric motors are correspondingly actuated via the provided electronic control system. In this way, at least one of the electric motors can be utilized in the generator mode in order to convert at least part of the mechanical power introduced by a rider of the electric bicycle into electrical power.

For example, the electronic control system is adapted to switch the drive system into the emergency mode in dependence on an energy storage signal and to actuate the first and second electric motors differently from a normal mode. Via the energy storage signal it is signaled to the electronic control system whether sufficient electric energy still is provided via an energy accumulator of the drive system. Here, signaling of a changed state and hence for switching into the emergency mode can be effected in particular by the absence of the energy storage signal. The energy storage signal correspondingly is also suited to signal whether an energy accumulator still is present at all. For example, via the energy storage signal the presence of a faultlessly operating energy accumulator, hence a battery, is signaled. When the battery has been removed or the battery is defective or empty, this is signaled to the electronic control system via the energy storage signal and the electronic control system herewith switches the drive system into the emergency mode. In the emergency mode of the drive system, at least one of the first and second electric motors then is differently actuated by the electronic control system as compared to a normal mode, in order to furthermore electronically steplessly adapt the gear ratio of the superposition transmission also in the emergency mode.

In one exemplary embodiment, the electronic control system for example is adapted to actuate one of the electric motors in the emergency mode with the aim to regulate an electric energy balance to zero within the drive system. Correspondingly, the electronic control system for example is adapted to process measurement signals via which a currently provided or consumed power of the individual electric motors each is signaled. In addition, the electronic control system possibly can also process measurement signals on a power consumption of possible loads present within the drive system or loads coupled with the drive system. In dependence on power values determined with reference to measurement signals and a resulting energy balance, the electronic control system then is able to actuate one of the electric motors in the emergency mode in such a way that the energy balance is regulated to zero. In other words, the power of this electric motor is regulated by the electronic control system in the emergency mode in such a way that an energy balance of zero is achieved.

In one design variant, the electronic control system in this connection for example is adapted
to actuate the second electric motor corresponding to a normal mode, in which the supply of the first and second electric motors with electric current is effected via the energy accumulator, and
to actuate the first electric motor of the drive system with the aim to regulate an electric energy balance within the drive system to zero.

Via the electronic control system and the regulation realized herewith, an actuation of the second electric motor consequently is maintained unchanged in the emergency mode of the drive system like in the normal mode, but in contrast to the normal mode a regulation of the first electric motor in dependence on the energy balance is provided. In general, one of the electric motors consequently is operated regeneratively and the other one is motor-driven, when the emergency mode of the drive system is active.

As already explained above, the electronic control system for the power control of the first and second electric motors in the emergency mode in this connection in particular can be adapted to take account of a power consumption of at least one load supplied with electric energy via the drive system and/or a power loss for the regulation of the electric motors. Consequently, a corresponding power consumption and/or power loss can be detected and be evaluated by the electronic control system in order to in particular actuate the one electric motor for a regenerative or motor-driven operation (with varying power) in dependence thereof. For example, when the first electric motor on the part of the power control is actuated in the emergency mode with the aim to regulate an electric energy balance within the drive system to zero, a power consumption of at least one load supplied with electric energy via the drive system and/or a measured power loss also is included in the regulation of the first electric motor in dependence on the energy balance.

In one design variant, the drive system comprises at least one energy buffer connected to the electronic control system, which is adapted and provided for buffering charge and hence for providing an intermediate circuit voltage. By providing an intermediate circuit via at least one associated energy buffer, the emergency mode possibly can be regulated in a more stable way.

For example, the electronic control system can be adapted to actuate one of the electric motors with the aim to hold the intermediate circuit voltage at a particular voltage value. A regulation provided with the electronic control system consequently aims at holding the intermediate circuit voltage and hence the electric energy present in the drive system at a constant (voltage) value. The intermediate circuit voltage can also be measured continuously, as it represents a direct feedback on the electric energy present in the drive system. The electronic control system can be adapted to process a measurement signal which is representative of the current intermediate circuit voltage of the drive system. On the basis of this measurement signal an actual voltage value can be determined and be compared with at least one setpoint voltage value. This setpoint voltage value can be stored in a memory of the electronic control system or be provided to the electronic control system via a separate voltage signal.

By means of the measurement value representative of the current intermediate circuit voltage, the electronic control system then for example can actuate the first electric motor in such a way that, when the actual voltage value drops below a first setpoint voltage value,
the first electric motor is actuated for a higher power generation when the first electric motor currently is operated regeneratively, or
the first electric motor is actuated for a lower power consumption when the first electric motor currently is motor-driven.

In principle, in particular by taking account of a power consumption of at least one load and/or a power loss it can occur that both the first electric motor and the second electric motor are motor-driven or regeneratively operated in the course of the emergency mode. However, when the intermediate circuit voltage drops below the first setpoint voltage value, the proposed design variant provides to operate the first electric motor more strongly in the direction of the regenerative operation, in order to supply more energy to the drive system (when the first electric motor currently is already operated regeneratively) or to withdraw less energy from the drive system (when the first electric motor currently is motor-driven).

Alternatively or additionally, the electronic control system can be adapted to actuate the first electric motor in dependence on the measurement signal representative of the current intermediate circuit voltage, namely in such a way that, when the actual voltage value rises above a second setpoint voltage value,
the first electric motor is actuated for a lower power generation when the first electric motor currently is operated regeneratively, or
the first electric motor is actuated for a higher power consumption when the first electric motor currently is motor-driven.

In this design variant, it consequently is provided that the first electric motor is operated more strongly in the direction of the motor operation in order to supply less energy to the drive system (when the first electric motor currently is operated regeneratively) or to withdraw more energy (when the first electric motor currently is already motor-driven), when the intermediate circuit voltage rises above a particular setpoint.

In principle, the first and second setpoint voltage values can be identical so that exactly one setpoint voltage value is relevant for the regulation. In order to avoid in a combination of the two exemplary embodiments described above that a regulation provided via the electronic control system immediately intervenes when a particular setpoint voltage value is exceeded or not reached, different first and second setpoint voltage values can be employed. In a tolerance range between the first setpoint voltage value and the second setpoint voltage value no intervention consequently is effected via the electronic control system and hence no changed actuation of the first electric motor.

One aspect of the present solution also relates to an electric bicycle with a proposed drive system.

In addition, there is proposed a control method in which a drive system for an electric bicycle (a motor-assisted bicycle) is operated in an emergency mode when the first and second electric motors of the drive system cannot be supplied with electric current via an energy accumulator. In the emergency mode, at least one of the first and second electric motors is at least temporarily operated regeneratively, in order to convert a (mechanical) power applied by muscle force at a drive shaft of the drive system into electric energy, which provides for a stepless variation of a gear ratio of a superposition transmission of the drive system also in the emergency mode.

A design variant of a proposed control method in particular can be realized with a design variant of a proposed drive system. Correspondingly, the advantages and features mentioned above and below for a design variant of a proposed drive system also apply for design variants of a proposed control method, and vice versa.

One design variant of a proposed control method can provide for example that in the emergency mode
the second electric motor is actuated corresponding to a normal mode, in which via the energy accumulator the supply of the first and second electric motors with electric current is effected at least temporarily (and possibly one of the electric motors is regeneratively operated only temporarily and supplies the energy accumulator), and
the first electric motor is actuated with the aim to regulate an electric energy balance within the drive system to zero.

Here as well, a power control in dependence on the energy balance and hence a regulation of the first electric motor in dependence on the energy balance consequently is provided in the emergency mode.

Alternatively or additionally, the drive system can comprise at least one energy buffer for generating an intermediate circuit voltage in the emergency mode for supplying at least one of the electric motors with electric current. One of the electric motors can then be actuated with the aim to hold the intermediate circuit voltage at a particular voltage value. In view of a changing mechanical power applied by muscle force at the drive shaft, a provided regulation then consequently aims at holding the intermediate circuit voltage for the supply of the second electric motor at a constant voltage value.

The proposed solution furthermore comprises a computer program product, for example embodied by a control software implemented in an electronic control system, which contains stored instructions which on execution by at least one processor of the electronic control system cause the at least one processor to execute a design variant of a proposed control method.

### BRIEF DESCRIPTION OF THE FIGURES

The attached Figures by way of example illustrate design variants of the proposed solution. In particular, the proposed solution can be applied in combination with a drive system as it has been described already in WO 2019/175022 A1. The proposed solution, however, is not limited thereto.

FIG. 1 shows details on an electronic control system for power control of a drive system for an electric bicycle in an emergency mode, wherein this drive system can be constructed for example as shown in one of the design variants of FIGS. 4 to 7.

FIG. 2 shows a development of the variant of FIG. 1 with an energy buffer and a regulation in dependence on the energy balance for a first electric motor of the drive system.

FIG. 3 shows a development of the design variant of FIG. 2, in which there is likewise provided an intermediate circuit voltage, but in contrast to the design variant of FIG. 2 the same is also utilized for regulating the first electric motor.

FIG. 4 shows a drive system known from the prior art with an output-side power split.

FIG. 5 shows a structural design of the drive system of FIG. 4.

FIG. 6 shows a drive system known from the prior art with a drive-side power split.

FIG. 7 shows a structural design of the drive system of FIG. 6.

FIGS. 8A-8B show diagrams for illustrating the operation of the drive system, wherein in the diagram of FIG. 8A a power P of second electric motors of the drive system is plotted over a (driving) velocity, and in the diagram of FIG. 8B a rotational speed of a drive shaft of the drive system to be effected by a rider of the electric bicycle is plotter over the velocity v.

### DETAILED DESCRIPTION

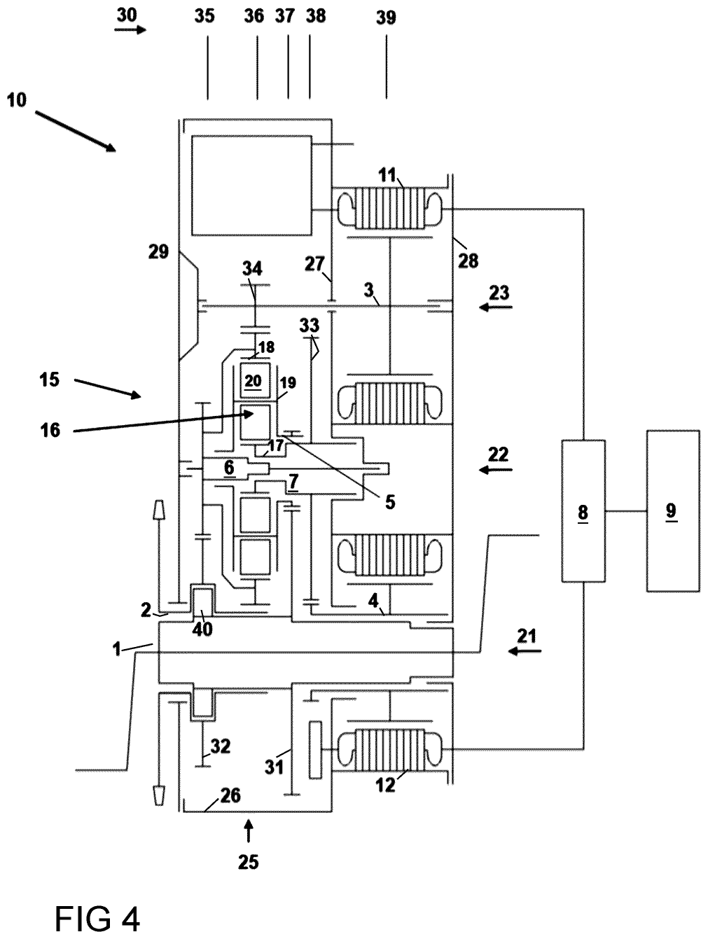

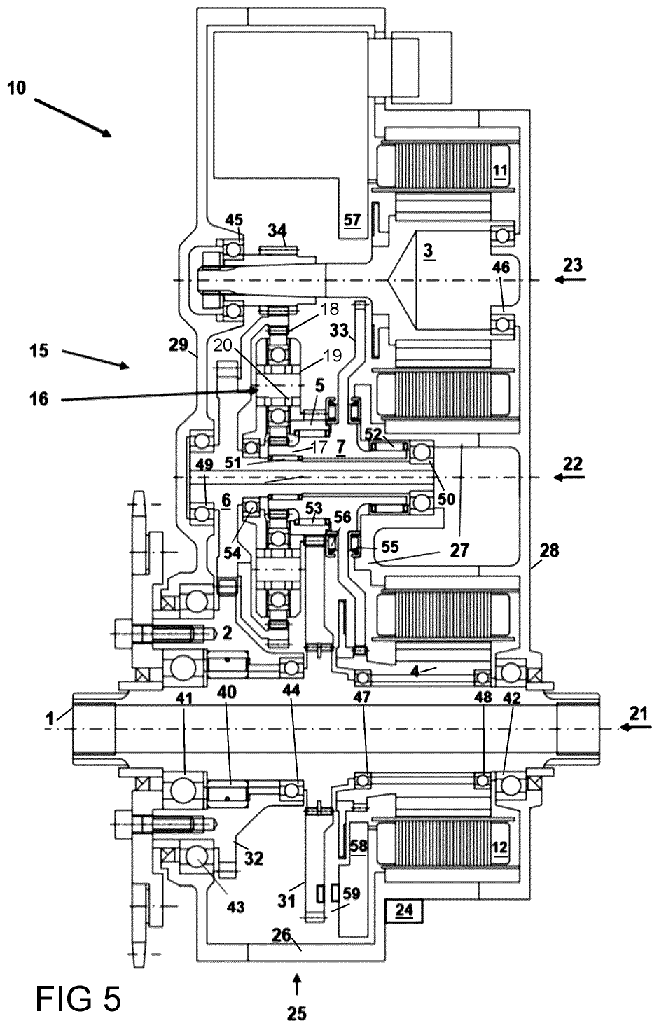

FIGS. 4 and 5 show a transmission structure and a 2D construction design of a drive system 10 known from the prior art between a drive shaft 1 and an output shaft 2 in a transmission housing 25 for application in an electric bicycle. The drive shaft 1 extends through the transmission housing 25 and on each side is connected to a pedal crank via which the rider drives the drive system 10. The output shaft 2 protrudes from the transmission housing 25 on only one side and is connected to a sprocket or a toothed belt pulley, in order to drive the rear wheel of the bicycle from there.

The drive system 10 includes a first motor 11 with a first rotor shaft 3. In this application, the motor is designed as an electric motor. The drive system 10 also has a second motor 12 with a second rotor shaft 4. In this application, the second motor 12 also is designed as an electric motor. The two electric motors 11 and 12 are connected via a power control 8 and hence form a stepless electric actuating gear. The power control 8 also is connected with an energy accumulator 9 in the form of a battery. As a result, the output shaft 2 can also be driven purely electrically via the first electric motor 11. The energy accumulator 9 then can also be utilized as a brake energy accumulator, when braking power flows into the drive system 10 at the output shaft 2.

The drive shaft 1, the output shaft 2 and the two rotor shafts 3 and 4 are coupled via a multistage superposition transmission 15, which includes a plurality of gear stages with a degree of freedom 1 and at least one planetary gear stage 16 with a degree of freedom 2. The gear stages here are designed as spur gear stages. However, toothed-belt gear stages also are conceivable. The three-shaft planetary gear stage 16 has a sun gear 17, a ring gear 18 and a planet carrier 19 with a plurality of planetary gears 20 which are mounted on planetary gear bolts.

The elements of the drive system 10 are distributed on three shaft trains 21, 22 and 23, which are all arranged parallel to each other in the available installation space of the transmission housing 25.

The drive shaft 1, the output shaft 2 and the second rotor shaft 4 of the second electric motor 12 are arranged coaxially on the first shaft train 21. The three-shaft planetary gear stage 16 of the multistage superposition transmission is arranged on the second shaft train 22. The first rotor shaft 3 of the first electric motor 11 is arranged on a third shaft train 23.

On the first shaft train 21 the outer output shaft 2 encloses the inner drive shaft 1 on one side of the transmission housing 25, and the second rotor shaft 4 encloses the drive shaft 1 on the other side of the transmission housing 25.

The arrangement of the three-shaft planetary gear stage 16 on the second shaft train provides for using a sun gear 17 of small diameter. This in turn provides for a quantitatively large gear ratio greater than |−4| with a still acceptably large ring gear 18. With such a large negative gear ratio, the simple and therefore narrow planetary gears 20 become so large that here sufficiently large narrow ball bearings can be mounted as planetary gear bearings. In general, this leads to a planetary gear stage 16 which advantageously is very short in an axial direction.

For the kinematic coupling of the elements of the drive system 10 distributed on the three shaft trains 21, 22 and 23 four gear stages designed as spur gear stages are used. Via a first spur gear stage 31, the drive shaft 1 on the first shaft train 21 is connected with a first coupling shaft 5 on the second shaft train 22. Via a second spur gear stage 32, the output shaft 2 on the first shaft train 21 is connected with a second coupling shaft 6 on the second shaft train 22. Via a third spur gear stage 33, the second rotor shaft 4 of the second electric motor 12 on the first shaft train 21 is connected with a third coupling shaft 7 on the second shaft train 22. This third coupling shaft also carries the sun gear 17. Via a fourth spur gear stage, the first rotor shaft 3 of the first electric motor 11 on the third shaft train 23 is connected with the ring gear 18 of the planetary gear stage 16 on the second shaft train 22.

The first spur gear stage 31 increases the rotational speed of the drive shaft 1 to an about three times greater absolute rotational speed of the first coupling shaft 5, which is connected with the second coupling shaft 6 via the planetary gear stage 16. The rotational speed of the second coupling shaft 6 is transmitted to an about 30% lower rotational speed of the output shaft 2 with the gear ratio of the second spur gear stage 32. The ratio of the gear ratios of the first spur gear stage 31 and the second spur gear stage 32, each defined as the ratio of the rotational speed of the gear wheel on the second shaft train 22 to the rotational speed of the gear wheel on the first shaft train 21, defines the maximum actuating coupling gear ratio between the first coupling shaft 5 and the second coupling shaft 6. For a high efficiency curve over the actuating coupling gear ratio in the actuating range, it is advantageous when the maximum and minimum actuating coupling gear ratios are approximately reciprocal. This can easily be achieved with such a design.

On the second shaft train 22, the first coupling shaft 5 is connected with the planetary carrier 19, the second coupling shaft 6 is connected with the ring gear 18, and the third coupling shaft is connected with the sun gear 17 of the planetary gear stage 16. As the first rotor shaft 3 of the first motor 11 is connected with the ring gear 18 and hence with the output shaft 2, the first design variant has an output side power split.

In FIG. 4, five arrangement planes 35, 36, 37, 38 and 39 are marked, whose numbers ascend in an axial direction 30. The axial direction 30 extends from the point at which the output shaft 2 exits from the transmission housing 25 into the transmission housing 25. It can be seen in FIG. 4 that the second spur gear stage 32 lies in the first arrangement plane 35 and that the planetary gear stage 16 and the fourth spur gear stage 34 lie in the second arrangement plane 36, which is offset in the axial direction 30 parallel to the first arrangement plane 35, and that the first spur gear stage 31 lies in a third arrangement plane 37, which is also offset from the second arrangement plane 36 in the axial direction 30, and that the third spur gear stage 33 lies in a fourth arrangement plane 38, which is also offset from the third arrangement plane 37 in the axial direction 30, and that the two motors 11 and 12 lie in a fifth arrangement plane, which likewise is offset from the fourth arrangement plane 38 in the axial direction 30.

The planetary gear stage 16 and the fourth spur gear stage 34 can lie in the same second arrangement plane 36, because the gear wheel of the fourth spur gear stage 34 on the second shaft train 22 has a greater pitch circle radius than the ring gear 18 of the three-shaft planetary gear stage 16. As a result, the ring gear 18 within this gear wheel of the fourth spur gear stage 34 can be mounted in the second arrangement plane 36.

This axial arrangement of the spur gear stages 31, 32, 33 and 34 in the surroundings of the planetary gear stage 16 on the second shaft train 22 in connection with the illustrated distribution of the drive elements on the three shaft trains 21, 22 and 23 leads to an extremely compact multistage superposition transmission 15.

FIGS. 4 and 5 also clearly show that the gear wheel of the first spur gear stage 31 on the first coupling shaft 5 has a greater pitch circle radius than the sun gear 17 on the third coupling shaft 7. During the assembly of the drive system 10, the sun gear 17 therefore can be put through the gear wheel on the first coupling shaft 5.

For an easy assembly of the remaining elements of the drive system 10 and their mounting in the transmission housing 25, the transmission housing 25 has four essential housing parts. The transmission housing 25 consists of a main housing 26 with a central web 27 connectable or connected therewith and a motor cover 28 connectable or connected with the main housing 26 on the side of the fifth arrangement plane 39 and a transmission cover 29 connectable or connected with the main housing 26 on the side of the first arrangement plane 35, through which the output shaft 2 protrudes from the transmission housing 25.

The construction design shown in FIG. 5 illustrates possible mountings of all shafts of the drive system 10 in the transmission housing 25 or on other shafts. It is the objective to realize statically determinate mountings with a large bearing distance and small bearing sizes. These are good prerequisites for low-noise and low-loss running of all shafts.

On the first shaft train 21, the drive shaft 1 is supported in the output shaft 2 via a first bearing 41 and in the motor cover 28 via a second bearing 42. The drive shaft 1 protrudes from the transmission housing 25 on both sides and undergoes large radial loads resulting from the drive. The bearings 41 and 42 have a maximally large distance for an optimum mounting of the drive shaft 1. The output shaft 2 is supported in the transmission cover 29 via a third bearing 43 and on the drive shaft via a fourth bearing 44. The bearings 41 and 43 are located approximately radially around each other so that the radial bearing load from the bearing 41 is supported directly in the transmission housing 25 via the bearing 43.

The first rotor shaft 3 is supported in the transmission cover 29 via a fifth bearing 45 and in the motor cover 28 via a sixth bearing 46. The bearing 46 can, however, also be placed between the central web 27 and the rotor shaft 3 with a similarly good function.

The second rotor shaft 4 is mounted on the drive shaft 1 via a seventh bearing 47 and an eighth bearing 48. The bearing 47 can, however, also be seated between rotor shaft 4 and central web 27, but then has a larger diameter. The bearing 48 might also be seated between rotor shaft 4 and motor cover 28, which however would also require more axial and radial installation space.

On the second shaft train 22, a plurality of shafts are mounted one within the other, but ultimately in the transmission housing 25. The second coupling shaft 6 is the maximally loaded shaft on the second shaft train 22 and therefore is designed as the innermost shaft, which via a ninth bearing 49 is mounted in the transmission cover 29 and via a tenth bearing 50 in the central web 27. This results in an advantageously large bearing distance. Alternatively, the bearing 50 can also be seated in the motor cover 28.

The third coupling shaft 7 is supported on the second coupling shaft 6 via an eleventh bearing 51 and is supported in the central web 27 via a twelfth bearing 52. The first coupling shaft 5 is supported on the third coupling shaft 7 via a thirteenth bearing 53 and on the second coupling shaft 6 via a fourteenth bearing 54. A fifteenth bearing 55 also transmits axial forces between the third coupling shaft 7 and the central web 27, and a sixteenth bearing 56 transmits axial forces between the first coupling shaft 5 and the third coupling shaft 7.

In the first arrangement plane 35 with the second spur gear stage 32 a freewheel 40 is located between the drive shaft 1 and the output shaft 2. This preferably is a clamping element freewheel, because this construction of a freewheel has a high torque capacity and can also use hardened cylindrical surfaces of the shafts to be coupled. In the constructional design as shown in FIG. 5, the freewheel however has its own inner ring and its own outer ring.

When the regulation in the power control 8 limits the maximum torque of the second motor 12, too large a driving torque not to be supported any more via the second motor 12 accelerates the drive shaft 1 to such an extent that the freewheel 40 automatically frictionally couples the drive shaft 1 with the output shaft 2. Hence, the freewheel 40 on the one hand serves as an overload protection of the drive system and on the other hand guarantees a basic mechanical function of the drive when there are problems in the electrical system, for example in the case of a voltage drop, or when there are problems in the control/regulation, for example in the case of a failure of sensors.

For a precise and reliable regulation of the drive system with a high drive comfort, the control requires precise signals in short cycle times. At and on the first rotor shaft 3 a first resolver 57 comprising sensor and sensor wheel therefor is seated for the exact measurement of the angular position and the rotational speed. At and on the second rotor shaft 4 a second resolver 58 is seated. A simple speed measurement system 59 in addition measures the rotational speed of the drive shaft 1. The high-precision resolvers 57 and 58 are prerequisites for an exact speed and/or torque regulation at the two motors 11 and 12. The additional and optional speed measurement system 58 at and on the drive shaft provides for a certain redundancy for a higher system safety. For example, it can serve to verify the plausibility of the resolver signals and provides for a function-reduced emergency function on failure of a resolver.

On the transmission housing 25 of FIG. 5 there is also mounted an acceleration and inclination sensor 24, as it is used today for example in many smartphones. From the acceleration and inclination signals in conjunction with the knowledge of the transmitted power, the system weight and the dynamics of the driving torque can be inferred. This information can be utilized in the power control to achieve a faster and more comfortable regulation.

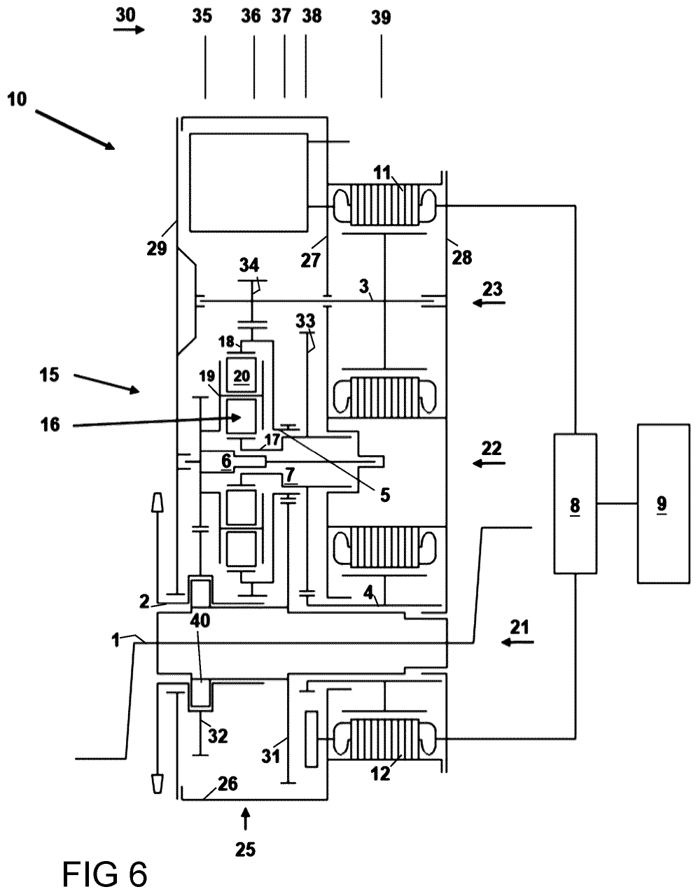

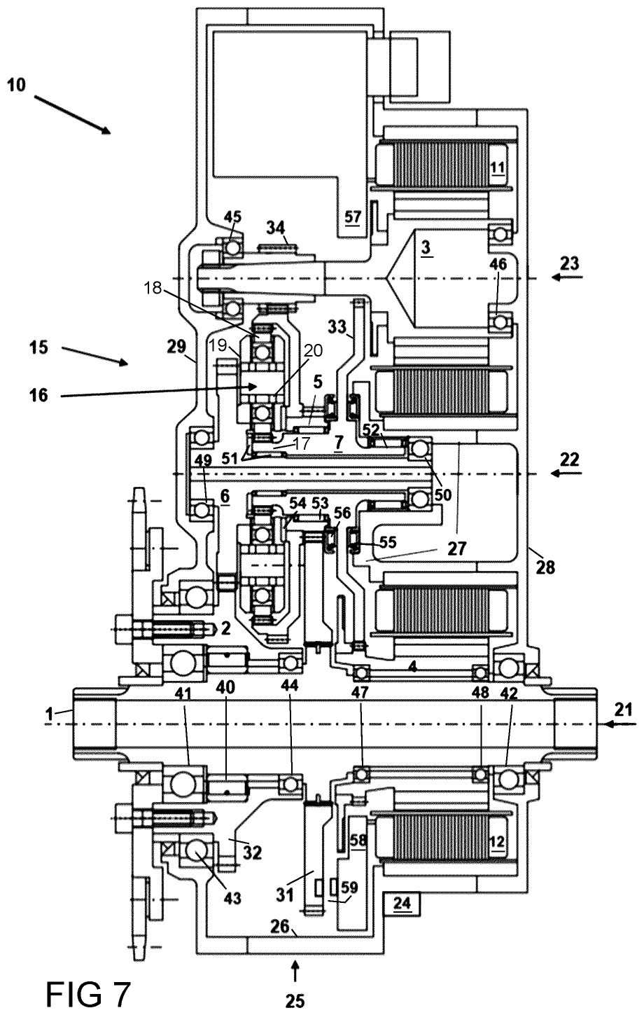

FIGS. 6 and 7 show a transmission structure and a 2D construction design of another drive system 10 known from the prior art between the drive shaft 1 and the output shaft 2 in a transmission housing 25 for application in an electric bicycle.

In the first design variant, the first coupling shaft 5 is connected with the planet carrier 9, and the second coupling shaft 6 is connected with the ring gear 18 of the planetary gear stage 20. In the second design variant, the first coupling shaft 5 is connected with the ring gear 18, and the second coupling shaft 6 is connected with the planet carrier of the planetary gear stage 20. These are the only structural differences between the two design variants.

As the first rotor 3 of the first motor 11 in both design variants is connected with the ring gear 18 via the fourth spur gear stage 34 (gear ratio in the range of 1-81), the rotational speeds of the output shaft 2 and the first rotor shaft 3 are proportional in the first design variant. In the second design variant, the rotational speeds of the drive shaft 1 and the first rotor shaft 3 are proportional. Both variants are technically expedient. In an electrically assisted bicycle drive, the first design variant is all the more advantageous the higher the electric assistance, because the electric assistance power then more directly acts from the energy accumulator 9 chiefly via the first motor 11 onto the driven wheel.

In the design variants of FIGS. 4 to 7, an emergency mode becomes possible via the freewheel 40, via which the drive system 10 still remains operable even when the energy accumulator 9 is removed, defective or empty. In this emergency mode, however, only one fixed gear ratio is provided, which corresponds to the smallest gear ratio in the normal mode. Hence, in the emergency mode-despite a high pedaling frequency at the drive shaft 1—only comparatively low velocities can be realized.

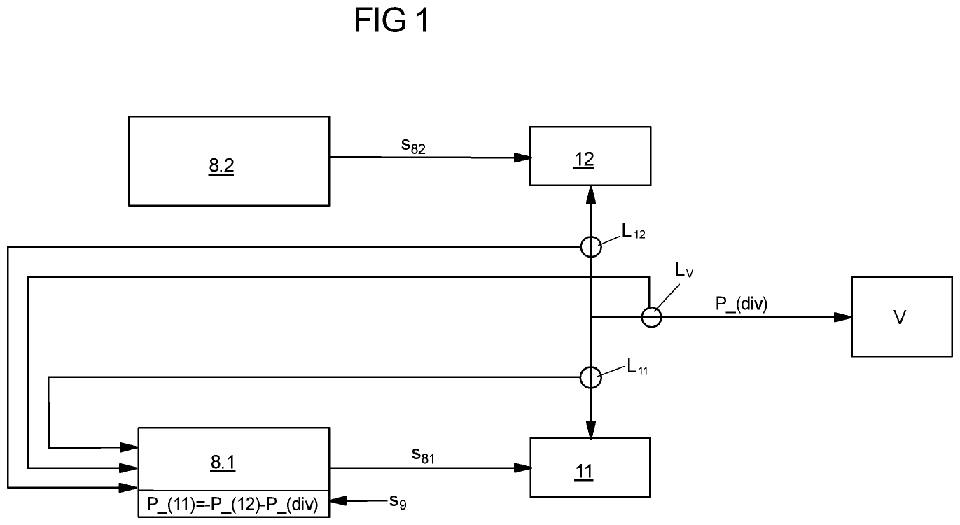

In this respect the proposed solution provides a remedy, possible design variants of which are illustrated with reference to FIGS. 1, 2 and 3.

These design variants aim at the provision of an electronic control system 8.1, 8.2 for a power control for first and second electric motors in an emergency mode of a drive system, in which by means of the electric motors a superposition transmission can be controlled to achieve a stepless variation of a gear ratio. The design variants of FIGS. 1, 2 and 3 thus can be used in particular for a power control of the first and second electric motors 11 and 12 in a drive system 10 of a design variant of FIGS. 4 to 7 and will subsequently be explained with reference to the design variants of FIGS. 4 to 7.

The electronic control system 8.1, 8.2 of FIGS. 1, 2 and 3 is each represented by two electronic control parts 8.1 and 8.2, via each of which control signals are transmitted to one of the electric motors 11 and 12. All the design variants of FIGS. 1, 2 and 3 have in common that via the electronic control system 8.1, 8.2 at least one of the electric motors, here by way of example the first electric motor 11, is at least temporarily operated regeneratively in an emergency mode, in order to convert a mechanical power applied at the drive shaft 1 by muscle force into electric energy, which furthermore provides for a stepless variation of the gear ratio of the superposition transmission 15 also in the emergency mode. The electronic control parts 8.1, 8.2 separately illustrated in the Figures can of course be part of a uniform microcontroller and are separately illustrated in the Figures merely for simplification of the drawing.

In the design variant of FIG. 1, the electronic control system 8.1, 8.2 is coupled with the first electric motor 11 (at the electronic control part 8.1) and evaluates an energy storage signal s₉, which indicates—possibly also by its absence—whether the energy accumulator 9 of the drive system 10 operates properly. In the present case, the energy storage signal s₉ is meant to be an external or system-internal signal and thus also a signal which signals a low-voltage event, i.e. the occurrence of too low a voltage value in the system (as compared to the stored reference value). In principle, an individual, specific value of the energy storage signal or a specific course of the energy storage signal over time can be decisive for the change into the emergency mode. For example, it is signaled via the energy storage signal s₉ whether the energy accumulator 9 and hence a battery of the drive system 10 has been removed, is defective or empty. If this is the case, the electronic control system 8.1, 8.2 switches the drive system 10 into an emergency mode and hence into another operating mode in which in particular the first electric motor 11 is operated differently from a normal mode.

The second electric motor 12 is actuated like in the normal mode via a control signal s₈₂ of the electronic control part 8.2, in order to furthermore steplessly vary the gear ratio of the superposition transmission 15 in dependence on a power to be output to the wheel of the electric bicycle and correspondingly maintain a moderate pedaling frequency at the drive shaft 1 also for a distinctly higher driving velocity. The first electric motor 11 on the other hand is actuated in the emergency mode via a control signal s₈₁ such that an electric energy balance is regulated to zero. For this purpose, a power determination L₁₁, L₁₂ and L_{V} is effected within the drive system 10. Here, corresponding measurement signals are tapped in order to detect a power decreasing over the second electric motor 12 (power determination L₁₂), a power decreasing over at least one load V (power determination L_{V}) and the power of the first electric motor 11 (power determination L₁₁) via measurement signals which are transmitted to the electronic control system or its electronic control part 8.1.

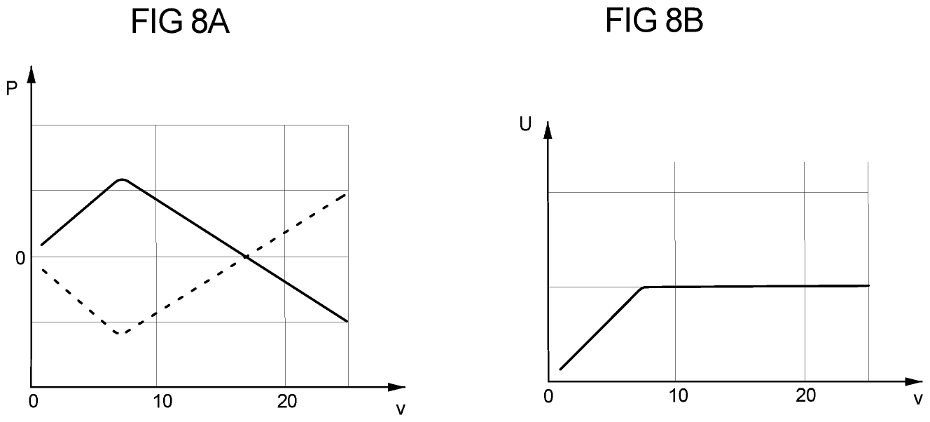

The power decreasing at the second electric motor 12 is indicated with P_(12) in FIG. 1, while the power decreasing over the load V is indicated with P_(div). Via the regulation provided by means of the electronic control system 8.1, 8.2, the power to be provided for the first electric motor 11, which is referred to as P_ (11), is calculated with P_(11)=−P_(12)−P_(div). In dependence on the determined energy balance and in particular the power P_(11) to be applied by the first electric motor 11, the electronic control system 8.1, 8.2 generates the appropriate control signal s₈₁ for the first electric motor 11 at the electronic control part 8.1, in order to correspondingly actuate the same. In general (in dependence on the desired cadence, driving velocity and system design), the electric motor 11 thus operates regeneratively, while the second electric motor 12 is motor-driven. This is illustrated in detail by way of example with reference to the diagrams of FIGS. 8A and 8B in dependence on a velocity of the electric bicycle achieved with the drive system 10. The diagram of FIG. 8A shows the power P of the two electric motors 11 and 12 over the velocity v, while the diagram of FIG. 8B shows the rotational speed U of the drive shaft 1 to be effected by the rider of the electric bicycle in dependence on the velocity v. It here can be seen that both electric motors 11 and 12 are operated regeneratively or motor-driven depending on the driving situation, in particular in order to be able to keep the revolution of the drive shaft 1 constant for the rider at a desired higher (driving) velocity v.

However, during the emergency mode situations can occur in which both the first electric motor 11 and the second electric motor 12 are motor-driven or operated regeneratively, for example due to a higher power P_(div) decreasing on the at least one load. The load V for example can represent an illumination necessarily to be supplied at the electric bicycle.

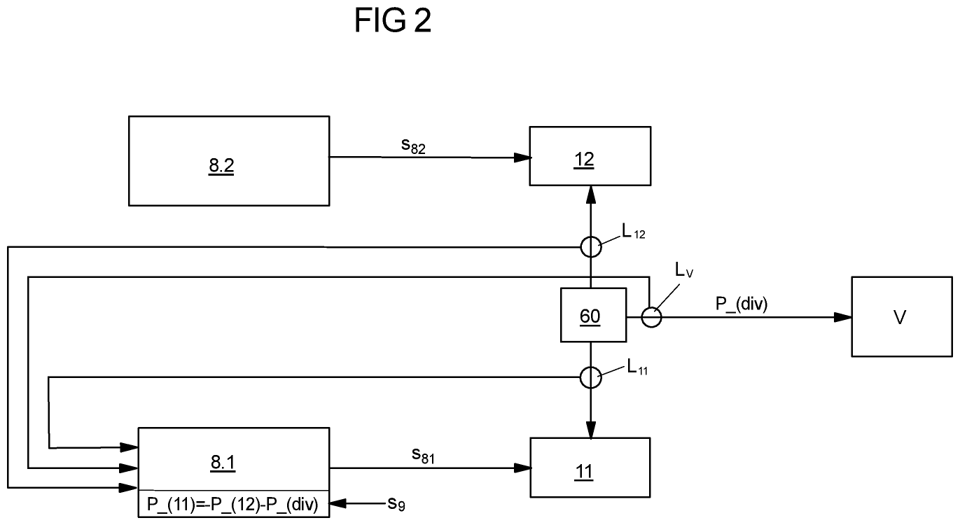

In the design variant of FIG. 2, the electronic control system 8.1, 8.2 is coupled with an energy buffer 60. This energy buffer 60 is formed e.g. by at least one intermediate circuit capacitor, a flywheel, a magnetic field arrangement or a hydraulic pressure accumulator, buffers charge or energy, and provides an intermediate circuit. Via the energy buffer 60 power losses can be compensated better and the emergency mode can be controlled in a more stable way. The electronic control system 8.1, 8.2 with the evaluation logic provided in the electronic control part 8.1 then for example aims at possibly maintaining the energy balance in the emergency mode at a constant value.

In a design variant with an intermediate circuit capacitor, the electronic control system 8.1, 8.2 with the evaluation logic provided in the electronic control part 8.1 then for example aims at possibly maintaining an intermediate circuit voltage in the emergency mode at a constant value. Here, the first electric motor 11 likewise is still operated in dependence on the energy balance. This means that via the power determinations L₁₂, L_{V} and L₁₁ the first electric motor 11 in particular is actuated by means of the control signal s₈₁ in such a way that the energy balance is regulated to zero.

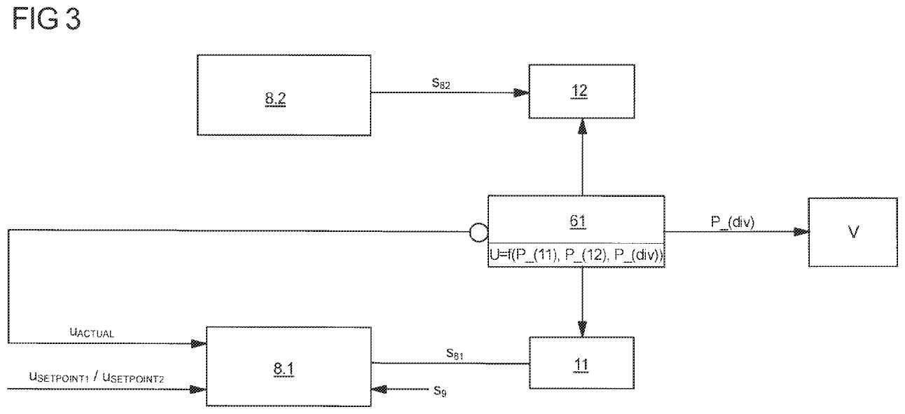

In the development of FIG. 3, an intermediate circuit capacitor 61 is provided as an energy buffer with an additional measuring tap for providing a measurement signal u_{ACTUAL} at the electronic control system 8.1, 8.2. In this way, in the design variant of FIG. 3, a regulation of the first electric motor 11 in the emergency mode is effected in dependence on a measured intermediate circuit voltage within the drive system 10, which is represented by the measurement signal u_{ACTUAL} and provided to the electronic control part 8.1. The measurement signal u_{ACTUAL} representative of the intermediate circuit voltage or an actual voltage value determined therefrom can then be compared with a setpoint voltage value within the electronic control system 8.1, 8.2, in order to actuate the first electric motor 11 in such a way that the actual voltage value corresponds to the setpoint voltage value or at least is approximated to the same.

Within the electronic control system, an individual and thus exactly one setpoint voltage value can be provided. It is, however, also possible that two different setpoint voltage values are provided, which differ from each other by a tolerance range. In the exemplary embodiment of FIG. 3, the different setpoint voltage values are provided to the electronic control part 8.1 via signals u_{SETPOINT1} and u_{SETPOINT2}.

The regulation shown in FIG. 3 aims at holding the intermediate circuit voltage and hence the electric energy present in the drive system 10 at a constant value. For example, when the intermediate circuit voltage measured via the measurement point of the at least one intermediate circuit capacitor 61 drops below a setpoint value, for example u_{SETPOINT1}, the electronic control system 8.1, 8.2 is used to operate the first electric motor 11 more strongly in the direction of a regenerative operation, in order to supply more energy to the drive system 10 (when the first electric motor 11 already is operated regeneratively) or to withdraw less energy (when the first electric motor currently is motor-driven). On the other hand, when the intermediate circuit voltage rises above a setpoint value, for example the setpoint u_{SETPOINT2}, the first electric motor 11 is operated more strongly in the direction of a motor operation, in order to supply less energy to the drive system 10 (when the first electric motor 11 currently is operated regeneratively) or to withdraw more energy (when the first electric motor 11 currently is already motor-driven). In a power regulation via an intermediate circuit voltage, power losses can be compensated automatically and the drive system 11 can be operated with smaller energy buffers and hence for example smaller intermediate circuit capacitors 61 (than in the design variant of FIG. 2).

The proposed solution provides a drive system 10 which in an emergency mode can provide a stepless automatic transmission function via a superposition transmission 15 even without an external energy supply and hence also without an (operable) energy accumulator 9. Thus, in this emergency mode, a comparatively high driving velocity still can also be achieved with a moderate pedaling frequency, in particular a higher driving velocity than would be possible in a solution known from the prior art solely with a freewheel 40, as it is shown in the design variants of FIGS. 4 to 7.

### LIST OF REFERENCE NUMERALS

1 drive shaft
2 output shaft
3 first rotor shaft
4 second rotor shaft
5 first coupling shaft
6 second coupling shaft
7 third coupling shaft
8 power control
8.1 electronic control part for first electric motor
9 energy accumulator
10 drive system
8.2 electronic control part for second electric motor
11 first electric motor
12 second electric motor
15 superposition transmission
16 three-shaft planetary gear stage PG
17 sun gear
18 ring gear
19 planet carrier
20 planetary gears
21 first shaft train
22 second shaft train
23 third shaft train
24 acceleration and inclination sensor
25 transmission housing
26 main housing
27 central web
28 motor cover
29 transmission cover
30 axial direction
31 first spur gear stage
32 second spur gear stage
33 third spur gear stage
34 fourth spur gear stage
35 first arrangement plane
36 second arrangement plane
37 third arrangement plane
38 fourth arrangement plane
39 fifth arrangement plane
40 freewheel
41-56 bearing
57 first resolver with sensor and sensor wheel
58 second resolver with sensor and sensor wheel
59 rotational speed measuring system
60 energy buffer
61 intermediate circuit capacitor
L₁₁, L₁₂, L_{V} power determination
s₈₁, s₈₂ control signal

s₉ energy storage signal

u_{ACTUAL} measurement signal

u_{SETPOINT1} setpoint signal

u_{SETPOINT2} setpoint signal

V load

1. A drive system for an electric bicycle, comprising
a drive shaft,
an output shaft for driving a wheel of the electric bicycle,
a first electric motor, which drives a first rotor shaft,
a second electric motor, which drives a second rotor shaft,
a superposition transmission, whose gear ratio is steplessly adjustable by means of the first and second electric motors and via which the drive shaft and the output shaft are coupled with each other, wherein a torque generated by the first electric motor can at least partly be transmitted to the output shaft, and
an energy accumulator for supplying the first and second electric motors with electric current,
wherein the drive system comprises an electronic control system for a power control of the first and second electric motors in an emergency mode of the drive system, wherein
the emergency mode is active when the first and second electric motors cannot be supplied with electric current via the energy accumulator, and
via the electronic control system, at least one of the first and second electric motors can at least temporarily be operated regeneratively in the emergency mode, in order to convert a power applied at the drive shaft by muscle force into electric energy, which provides for a stepless variation of the gear ratio of the superposition transmission also in the emergency mode.

2. The drive system according to claim 1, wherein in the emergency mode the electronic control system for the power control of the first and second electric motors is adapted to actuate one of the electric motors with the aim to regulate an electric energy balance within the drive system to zero.

3. The drive system according to claim 2, wherein in the emergency mode the electronic control system for the power control of the first and second electric motors is adapted
to actuate the second electric motor corresponding to a normal mode, in which the supply of the first and second electric motors with electric current is effected via the energy accumulator, and
to actuate the first electric motor with the aim to regulate an electric energy balance within the drive system to zero.

4. The drive system according to claim 2, wherein in the emergency mode the electronic control system for the power control of the first and second electric motors is adapted to take account of a power consumption of at least one load supplied with electric energy via the drive system and/or a power loss for the regulation of the one electric motor.

5. The drive system according to claim 1, wherein the drive system comprises at least one energy buffer connected to the electronic control system.

6. The drive system according to claim 5, wherein in the emergency mode the electronic control system for the power control of the first and second electric motors is adapted to actuate one of the electric motors with the aim to hold an intermediate circuit voltage provided via the energy buffer at a particular voltage value.

7. The drive system according to claim 6, wherein the electronic control system is adapted for processing a measurement signal which is representative of the current intermediate circuit voltage of the drive system.

8. The drive system according to claim 7, the electronic control system is adapted to compare an actual voltage value detected on the basis of the measurement signal with at least one setpoint voltage value.

9. The drive system according to claim 3, wherein
the drive system comprises at least one energy buffer connected to the electronic control system,
in the emergency mode the electronic control system for the power control of the first and second electric motors is adapted to actuate one of the electric motors with the aim to hold an intermediate circuit voltage provided via the energy buffer at a particular voltage value,
the electronic control system is adapted for processing a measurement signal which is representative of the current intermediate circuit voltage of the drive system,
the electronic control system is adapted to compare an actual voltage value detected on the basis of the measurement signal with at least one setpoint voltage value and
the electronic control system is adapted to actuate the first electric motor in dependence on the measurement signal representative of the current intermediate circuit voltage, namely in such a way that, when the actual current value drops below a first setpoint voltage value,
the first electric motor is actuated for a higher power generation when the first electric motor currently is operated regeneratively, or
the first electric motor is actuated for a lower power consumption when the first electric motor currently is motor-driven.

10. The drive system according to claim 3, wherein
the drive system comprises at least one energy buffer connected to the electronic control system,
in the emergency mode the electronic control system for the power control of the first and second electric motors is adapted to actuate one of the electric motors with the aim to hold an intermediate circuit voltage provided via the energy buffer at a particular voltage value,
the electronic control system is adapted for processing a measurement signal which is representative of the current intermediate circuit voltage of the drive system,
the electronic control system is adapted to compare an actual voltage value detected on the basis of the measurement signal with at least one setpoint voltage value and
the electronic control system is adapted to actuate the first electric motor in dependence on the measurement signal representative of the current intermediate circuit voltage, namely in such a way that, when the actual current value rises above a second setpoint voltage value,
the first electric motor is actuated for a lower power generation, when the first electric motor currently is operated regeneratively, or
the first electric motor is actuated for a higher power consumption, when the first electric motor currently is motor-driven.

11. An electric bicycle with a drive system according to claim 1.

12. A method for controlling a drive system for an electric bicycle, the drive system comprising:
a drive shaft,
an output shaft for driving a wheel of the electric bicycle,
a first electric motor, which drives a first rotor shaft,
a second electric motor, which drives a second rotor shaft,
a superposition transmission, whose gear ratio is steplessly adjustable by means of the first and second electric motors and via which the drive shaft and the output shaft are coupled with each other, wherein a torque generated by the first electric motor can at least partly be transmitted to the output shaft, and
an energy accumulator for supplying the first and second electric motors with electric current,
wherein the drive system is operated in an emergency mode when the first and second electric motors cannot be supplied with electric current via the energy accumulator, wherein in the emergency mode at least one of the first and second electric motors is at least temporarily operated regeneratively, in order to convert a power applied by muscle force at the drive shaft into electric energy, which provides for a stepless variation of the gear ratio of the superposition transmission also in the emergency mode.

13. The method according to claim 12, wherein in the emergency mode
the second electric motor is actuated corresponding to a normal mode, in which the supply of the first and second electric motors with electric current is effected via the energy accumulator, and
the first electric motor is actuated with the aim to regulate an electric energy balance within the drive system to zero.

14. The method according to claim 12, wherein the drive system comprises at least one energy buffer for generating an intermediate circuit voltage in the emergency mode for supplying at least one of the electric motors with electric current, and one of the electric motors is actuated with the aim of holding the intermediate circuit voltage at a particular voltage value.

15. A computer program product, including instructions which on execution by at least one processor of an electronic control system for a drive system of an electric bicycle cause the at least one processor to carry out a method according to claim 12.
